(19) United States
(12) Patent Application Publication
(10) Pub. No.: US 2026/0029931 A1
(43) Pub. Date: Jan. 29, 2026

(54) READ ERROR HANDLING OPERATIONS WITH SHORTER SENSING TIME

(71) Applicant: Micron Technology, Inc., Boise, ID (US)

(72) Inventors: Yu-Chung Lien, San Jose, CA (US); Zhenming Zhou, San Jose, CA (US)

(21) Appl. No.: 19/275,735

(22) Filed: Jul. 21, 2025

Related U.S. Application Data
(60) Provisional application No. 63/676,288, filed on Jul. 26, 2024.

(51) Int. Cl. G06F 3/06

(52) U.S. Cl. CPC G06F 3/0619; G06F 3/0655; G06F 3/0679

(57) ABSTRACT

Methods, systems, and devices for read error handling (REH) operations with shorter sensing time are described. For example, a memory system may use a shorter sensing duration (e.g., relative to nominal read operations outside an REH procedure) for performing read operations in the REH procedure, which may reduce BEC and shorten the read duration to increase read performance. Shorter sensing durations may inherently upshift the voltage threshold distribution of memory cells, increasing their reliability and decreasing an associated bit error count. The shorter sensing durations may be used for any read operation performed in the REH procedure. In some cases, the memory system may enter a REH procedure for a block family (e.g., for a sequential read operation). In such cases, the memory system may read the remaining blocks in the block family using the shorter sensing duration after exiting the REH procedure.

### CROSS REFERENCE

The present Application for Patent claims priority to U.S. Patent Application No. 63/676,288 by Lien et al., entitled “READ ERROR HANDLING OPERATIONS WITH SHORTER SENSING TIME,” filed Jul. 26, 2024, which is assigned to the assignee hereof, and which is expressly incorporated by reference in its entirety herein.

### TECHNICAL FIELD

The following relates to one or more systems for memory, including read error handling operations with shorter sensing time.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports read error handling (REH) operations with shorter sensing time in accordance with examples as disclosed herein.

FIG. 2 shows an example of a voltage diagram that supports REH operations with shorter sensing time in accordance with examples as disclosed herein.

FIGS. 3 and 4 show examples of process flows that support REH operations with shorter sensing time in accordance with examples as disclosed herein.

FIG. 5 shows a block diagram of a memory system that supports REH operations with shorter sensing time in accordance with examples as disclosed herein.

FIG. 6 shows a flowchart illustrating a method or methods that support REH operations with shorter sensing time in accordance with examples as disclosed herein.

### DETAILED DESCRIPTION

Some memory systems may enter a read error handling (REH) procedure based on detecting a bit error count (BEC) that exceeds a BEC threshold when performing one or more read operations. The REH procedure may include one or more stages that each include one or more operations that may adjust a read level voltage to minimize the BEC. Current systems may utilize longer read sensing durations in the REH procedure. Performing a REH procedure may typically shift the read level of memory cells downwards (e.g., the cells may lose charge). Additionally, as memory cells become smaller, their reliability and read performance may degrade. Thus, performing the REH procedure with longer sensing durations may not provide as much benefit, as longer sensing durations may further downshift the read level of the memory cells.

The techniques described herein may enable a shorter sensing duration (e.g., relative to nominal read operations outside the REH procedure) for performing read operations in the REH procedure, which may reduce BEC and shorten the read duration to increase read performance. Shorter sensing durations may inherently upshift the voltage threshold distribution of memory cells, increasing their reliability and decreasing an associated BEC. The shorter sensing durations may be used for any read operation performed in the REH procedure. In some cases, the memory system may enter a REH procedure for a block family (e.g., for a sequential read operation). In such cases, the memory system may read the remaining blocks in the block family using the shorter sensing duration after exiting the REH procedure. Block families may be based on storing sequential data (e.g., data that was written in the same time window at similar temperatures/operating conditions). The shorter sensing duration may be used on block families because the blocks in the block family may share similar data retention characteristics. Reading the remaining blocks in the block family in accordance with the shorter sensing duration may increase read performance compared to memory systems that may read each block in the block family using the nominal (e.g., comparatively longer) sensing duration.

In addition to applicability in memory systems as described herein, techniques for REH operations with shorter sensing durations may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing BEC associated with performing read operations (e.g., a REH procedure may thus be entered less often), and reducing read times for cells, which may decrease processing or latency times, improve response times, or otherwise improve user experience, among other benefits.

Features of the disclosure are illustrated and described in the context of systems, devices, and circuits. Features of the disclosure are further illustrated and described in the context of a voltage diagram, process flows, and flowcharts.

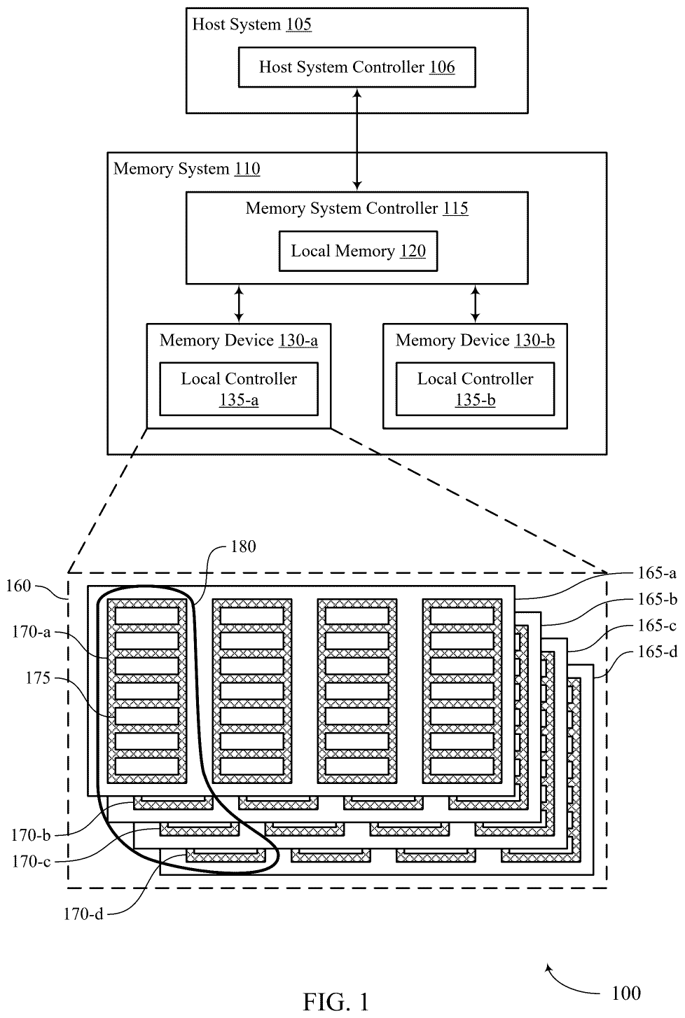

FIG. 1 shows an example of a system 100 that supports REH operations with shorter sensing time in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IOT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

Some memory systems 110 may enter an REH procedure based on detecting a BEC that exceeds a BEC threshold when performing one or more read operations. The REH procedure may include one or more stages that each include one or more operations that may adjust a read level voltage to minimize the BEC. Current systems may utilize longer read sensing durations in the REH procedure. For example, the REH procedure may perform a read operation in accordance with a longer sensing time relative to a nominal read operation sensing time (e.g., a sensing time used for read operations completed outside of the REH procedure). In some examples, the memory system 110 may use the longer sensing time to recover reliability, such as in an enhanced corrective read operation. Performing a REH procedure may typically shift the read level of memory cells downwards (e.g., the cells may lose charge). Additionally, as memory cells become smaller, their reliability and read performance may degrade. Thus, performing the REH procedure with longer sensing durations may not provide as much benefit, as longer sensing durations may further downshift the read level of the memory cells.

The techniques described herein may enable a shorter sensing duration (e.g., relative to nominal read operations outside the REH procedure) for performing read operations in the REH procedure, which may reduce BEC and shorten the read duration to increase read performance. Shorter sensing durations may inherently upshift the voltage threshold distribution of memory cells, increasing their reliability and decreasing an associated BEC. The shorter sensing durations may be used for any read operation performed in the REH procedure. In some cases, the memory system 110 may enter a REH procedure for a block family (e.g., for a sequential read operation). In such cases, the memory system 110 may read the remaining blocks in the block family using the shorter sensing duration after exiting the REH procedure. Block families may be based on storing sequential data (e.g., data that was written in the same time window at similar temperatures/operating conditions). The shorter sensing duration may be used on block families because the blocks (e.g., one or more blocks 170) in the block family may share similar data retention characteristics. Reading the remaining blocks in the block family in accordance with the shorter sensing duration may increase read performance compared to memory systems 110 that may read each block 170 in the block family using the nominal (e.g., comparatively longer) sensing duration. In some examples, the techniques described herein may apply to single-level cells (SLCs).

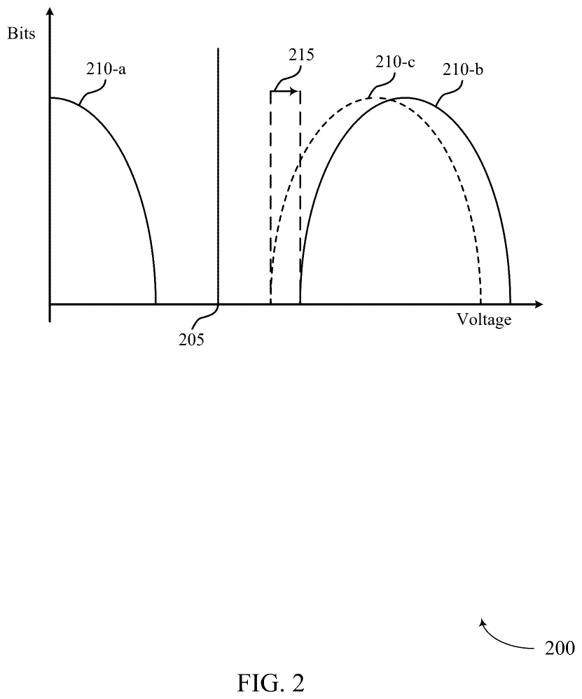

FIG. 2 shows an example of a voltage diagram 200 that supports REH operations with shorter sensing time in accordance with examples as disclosed herein. For example, the voltage diagram may include a first voltage distribution 210-a, a second voltage distribution 210-b, and a third voltage distribution 210-c. The voltage diagram 200 may be implemented by aspects of the system 100 as described with reference to FIG. 1. For example, the first voltage distribution 210-a and the second voltage distribution 210-b (e.g., and/or the third voltage distribution 210-c) may correspond to a logic level for one or more memory cells associated with one or more blocks 170 and planes 165, as described with reference to FIG. 1. Each logic level may further be defined to be above an associated read level 205, where read level 205 may correspond to a first logic level for the second and third voltage distributions 210-b and 210-c. In some examples, the read level 205 may represent a threshold voltage defining a logic level. For example, voltages above the read level 205 may correspond to a logic ‘1’ (or ‘0’) whereas voltages below the read level 205 may correspond to a logic ‘0’ (or ‘1’). The voltage distributions 210 may increase vertically in the diagram to illustrate an increased quantity of bits (e.g., and associated memory cells) corresponding to a respective voltage (e.g., for a random set of data) and may correspond to a higher likelihood of bits at each voltage.

In some examples, the first voltage distribution 210-a and the second voltage distribution 210-b may be voltage threshold (VT) distributions. That is, the first voltage distribution 210-a and the second voltage distribution 210-b may represent an example distribution of voltages. A VT distribution may be associated with a predictable (e.g., expected, configured) voltage level for a given logic state. For example, a memory system (e.g., the memory system 110) may read or write data according to the first voltage distribution 210-a, the second voltage distribution 210-b, or both. In some examples, the second voltage distribution 210-b (and/or the first voltage distribution 210-a) may shift (e.g., drift or migrate) over time by a delta 215 due to, for example, degradation of the memory system, among other examples. For example, applying a program level may downshift (e.g., memory cells may lose charge) the second voltage distribution 210-b to become the third voltage distribution 210-c. Additionally, or alternatively, applying an erase level may upshift the first voltage distribution 210-a towards the read level 205. That is, one or more memory cells may gain charge based on applying an erase level to the one or more memory cells. In some examples, the delta 215 may be unknown to the memory system (e.g., the shifted distance may be relatively random or unpredictable). In some examples, the magnitude of the delta 215 (e.g., the amount of drift) over time may correspond to a data retention characteristic of the corresponding memory cells in the voltage distributions 210. For example, the data retention characteristic may refer to the reliability and longevity of one or more memory cells, which may correspond to the amount of drift a voltage distribution 210 of a respective cell experiences.

In some examples, the third voltage distribution 210-c may increase a BEC of the one or more bits (e.g., and corresponding memory cells) based on being shifted the delta 215 from the second voltage distribution 210-b. For example, a voltage for a memory cell that was within a first logic level may now shift beyond into a second logic level. That is, the shifted voltage may change the associated logic value of the memory cell (e.g., change the value of the bit). For example, a memory cell that was previously associated with a logic ‘1’ within the second voltage distribution 210-b may now be read as a logic ‘0’ within the third voltage distribution 210-c. In some examples, the third voltage distribution 210-c may overlap different voltage levels for logic states, which may increase error and uncertainty when reading the one or more memory cells. For example, the memory system may not accurately obtain a logic state for memory cells shifted near the read level 205.

Some memory systems may use an REH procedure to reduce the BEC when performing one or more read operations. For example, a memory system may perform a first set of one or more read operations and detect a BEC that exceeds a threshold after performing the first set of one or more read operations. In response to detecting that the BEC exceeds the threshold, the memory system may enter the REH procedure. An REH procedure may include one or more operations that may decrease the BEC. For example, the REH procedure may include one or more operations to shift the read level 205 such that the memory system reads the third voltage distribution 210-c relatively more accurately (e.g., to compensate for the delta 215). Additionally, the REH procedure may include one or more operations to perform a relatively more delicate read method (e.g., applying more granular changes in applied voltage for the read level 205), such as a parallel auto-read calibration (pARC) operation, or a corrective read (CR) operation, among other examples. The memory system may progress through one or more stages (e.g., that each may include one or more operations) of the REH procedure until the memory system detects a BEC less than the threshold. In such cases, the memory system may exit the REH procedure and resume nominal operations (e.g., read, write, refresh, etc.).

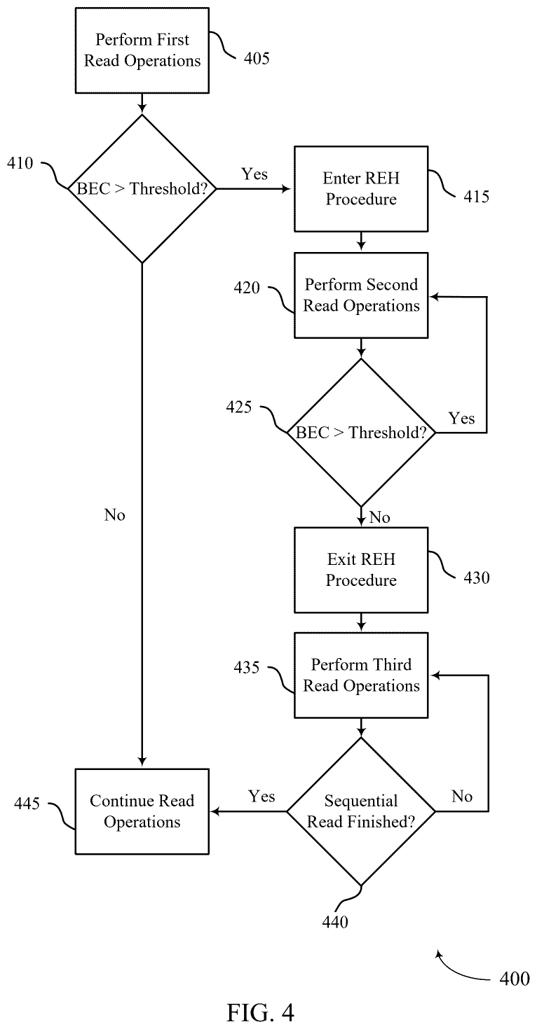

As described further with reference to FIG. 4, one or more blocks may share the same, or relatively similar, data retention characteristics. These blocks may be grouped into a “block family.” Block families may be created based on being written (e.g., programmed) in a same time window, temperature, or any combination thereof. For example, writing sequential data to one or more blocks may result in a block family corresponding to the sequential data (e.g., since sequential data may be written in a relatively short duration). Thus, if one page of a block family enters an REH procedure based on a BEC exceeding the threshold, it may be likely that the remaining pages of the block family may generate a BEC that exceeds the threshold. Entering, and subsequently exiting, the REH procedure for each block in a block family may result in read performance degradation. Additionally, as memory cell sizes become smaller, the data retention characteristic of a respective memory cell may degrade, which may result in more time spent entering and moving through the REH procedure.

The techniques described herein enable an REH procedure that uses one or more shorter sensing times (e.g., relative to a sensing time for a read operation outside of the REH procedure) to reduce BEC and enable shorter read times, which may improve overall read performance. For example, performing nominal read operations, or an REH procedure with nominal read operations, in accordance with a first (e.g., nominal) sensing duration may result in the third voltage distribution 210-c that may be associated with a relatively higher BEC. However, applying a shorter sensing duration in the REH procedure, as described herein, may result in an upward shift (e.g., the delta 215) of the third voltage distribution 210-c to become the second voltage distribution 210-b. That is, reading in accordance with the shorter sensing duration may reduce the BEC based on shifting the third voltage distribution 210-c away from the read level 205. In some examples, the memory system may perform one or more read operations on blocks in a block family in accordance with one or more shorter sensing times, as described with reference to FIG. 4. Although described with reference to a NAND system, the techniques described herein may be applicable to any non-volatile memory system with an REH procedure (e.g., resistive RAM (ReRAM), PCM, and the like) and any block usage such as normal block, block by deck (BBD), partial group block (PGB), partial block (PB), or any combination thereof.

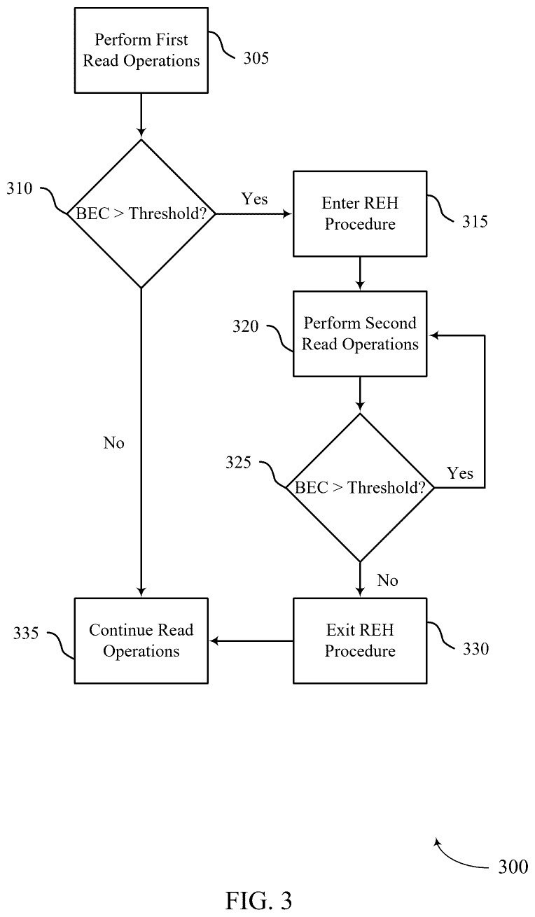

FIG. 3 shows an example of a process flow 300 that supports REH operations with shorter sensing time in accordance with examples as disclosed herein. The process flow 300 may be implemented by aspects of the system 100 as described with reference to FIG. 1. For example, the process flow 300 may be implemented by a memory system, which may be an example of the memory system 110. The process flow 300 may be an example of a process flow for entering a REH procedure and performing one or more read operations in accordance with a shorter sensing duration (e.g., relative to a nominal read operation outside of the REH procedure) as described herein.

In the following description of the process flow 300, the operations may be performed in a different order than the order shown, or other operations may be added or removed from the process flow 300. For example, some operations may also be left out of the process flow 300, may be performed in different orders or at different times, or other operations may be added to the process flow 300. Although a memory system (e.g., the memory system 110) may perform the operations of the process flow 300, some aspects of some operations may also be performed by one or more other memory systems, memory devices, host devices, controllers, or other electronic devices (e.g., as described herein with respect to FIG. 1).

At 305, the memory system may perform a first set of one or more read operations in accordance with a first sensing duration. The first sensing duration may be a nominal sensing duration. For example, the memory system may perform a majority of read operations (e.g., read operations outside of a REH procedure) in accordance with the first sensing duration. In some examples, performing the first set of one or more read operations may generate a first quantity of bit errors (e.g., a BEC) associated with one or more blocks read by the first set of one or more read operations. That is, a shift of a voltage distribution of the one or more blocks may result in one or more bit errors, as described with reference to FIG. 2.

At 310, the memory system may determine whether the first quantity of bit errors exceeds a threshold. If the memory system detects that the first quantity of bit errors does not exceed the threshold (e.g., relatively little to no errors detected), the memory system may continue performing nominal read operations at 335 in accordance with the first sensing duration. If the memory system detects that the first quantity of bit errors exceeds the threshold, the memory system may enter a REH procedure at 315. The REH procedure may include one or more operations that may decrease the quantity of bit errors. For example, at 320, the memory system may perform a second set of one or more read operations during the REH procedure. The memory system may perform the second set of one or more read operations in accordance with one or more second sensing durations that are each shorter than the first sensing duration (e.g., each of the second sensing durations are shorter than the nominal sensing duration). In some examples, the one or more shorter sensing durations may be stored in the memory system as any floating-point number.

The memory system may implement the one or more second sensing durations in the REH procedure using various methods. In a first example, the memory system may perform any read operation in accordance with the second sensing duration (e.g., a read command may be bundled with the shorter sensing duration). That is, during the REH procedure, the memory system may use the shorter sensing duration for read operations. As described further with reference to FIG. 4, the memory system may also perform one or more read operations in accordance with the shorter sensing time for a block family read (e.g., instead of a normal, or nominal, read operation). In a second example, the memory system may change a sensing duration parameter from a first value corresponding to the first sensing duration to a second value corresponding to the shorter sensing duration. For example, the memory system may change the sensing duration parameter via a multi-layer board interface (MLBi). The MLBi may be a test interface that enables a user to have command access to change (e.g., test) different types and values of parameters of the memory system. In some examples, the memory system may change the sensing duration parameter using any interface between one or more memory devices (e.g., a memory device 130) and the memory system controller (e.g., the memory system controller 115). In some cases, changing the sensing duration parameter may be associated with an overhead (e.g., a time delay). However, based on changing the sensing duration parameter, the memory system may perform read operations (e.g., outside the REH procedure for block family reads) in accordance with the second sensing duration, as described further with reference to FIG. 4. Thus, changing the sensing parameter may result in faster read performance compared to performing read operations in accordance with the first sensing duration (e.g., any overhead from changing the parameter may be negated by the read speed increase from the shorter sensing duration).

In some examples, the second set of one or more read operations may include one or more re-read operations, one or more read last operations, or both, among other REH procedure operations (e.g., other operations that may reduce the BEC). A respective re-read operation may include applying a read voltage to one or more blocks in accordance with the first sensing duration (e.g., when performing the first set of one or more read operations) and reapplying the read voltage to the one or more blocks in accordance with the one or more second sensing durations. In some cases, reapplying the read voltage (e.g., performing a re-read) may result in second quantity of bit errors fewer than the first quantity of bit errors.

In some examples, a respective read last operation may include obtaining read information associated with one or more blocks (e.g., of a block family). For example, the read information may include a read voltage applied to the one or more blocks during a previous REH procedure. Based on obtaining the read information, the memory system may apply the read voltage to the one or more blocks in accordance with the one or more second sensing durations. In some cases, applying the read voltage via the read last operation may result in a second quantity of bit errors fewer than the first quantity of bit errors. In some examples, a shorter sensing duration for one operation of the REH procedure, such as a re-read operation, may be different than a shorter sensing duration for another operation of the REH procedure, such as a read last operation. Additionally, or alternatively, different stages of the REH procedure may use different shorter sensing durations (e.g., a first stage may use a first shorter sensing duration and a second stage may use a second shorter sensing duration).

At 325, the memory system may determine whether performing the second set of one or more read operations in accordance with the one or more second sensing durations generated a quantity of bit errors less than the threshold. That is, the memory system may perform a respective stage of the REH procedure that includes one or more read operations of the second set of read operations. Based on completing a respective stage the memory system may determine whether a quantity of bit errors generated (e.g., or not generated) is less than the threshold. If the memory system detects that the quantity of bit errors is greater than the threshold, the memory system may perform an additional second set of one or more read operations in accordance with the one or more second sensing durations. That is, the memory system may progress through the REH procedure to a next stage. For example, based on entering the REH procedure at 315, the memory system may perform a re-read operation as the second set of one or more read operations in a first stage. If performing the re-read operation did not result in a BEC fewer than the threshold, the memory system may perform a read-last operation as the additional second set of one or more read operations in a second stage. The memory system may continue through one or more stages of the REH procedure in a similar manner (e.g., applying varying operations in accordance with the one or more second sensing durations) until detecting that the bit error quantity associated with performing the second set of one or more read operations results is less than the threshold.

At 330, the memory system may exit the REH procedure based on detecting that the bit error quantity is less than the threshold. For example, the memory system may perform one or more stages of the REH procedure and the most-recently completed stage may result in a BEC less than the threshold. In some examples, the memory system may store the read level (e.g., the read level 205 as described with reference to FIG. 2) of the most-recently completed read operation in read information corresponding to the one or more blocks read in accordance with the second sensing duration. That is, based one exiting the REH procedure, the memory system may store the read level (e.g., the read level that successfully decreased the BEC) for future REH procedures for a respective block. At 335, the memory system may continue read operations (e.g., nominal read operations) in accordance with the first sensing duration.

FIG. 4 shows an example of a process flow 400 that supports REH operations with shorter sensing time in accordance with examples as disclosed herein. The process flow 400 may be implemented by aspects of the system 100 as described with reference to FIG. 1. For example, the process flow 400 may be implemented by a memory system, which may be an example of the memory system 110. The process flow 400 may be a continuation of the process flow 300 as described with reference to FIG. 3. For example, the process flow 400 may be an example of a process flow for performing one or more read operations on blocks in a block family in accordance with a shorter sensing duration (e.g., relative to a nominal sensing duration) after exiting a REH procedure as described herein.

In the following description of the process flow 400, the operations may be performed in a different order than the order shown, or other operations may be added or removed from the process flow 400. For example, some operations may also be left out of the process flow 400, may be performed in different orders or at different times, or other operations may be added to the process flow 400. Although a memory system (e.g., the memory system 110) may perform the operations of the process flow 400, some aspects of some operations may also be performed by one or more other memory systems, memory devise, host devices, controllers, or other electronic devices (e.g., as described herein with respect to FIG. 1).

The memory system may perform steps 405 through 430 as described with reference to steps 305 through 330 in FIG. 3. For example, at 405, the memory system may perform a first set of one or more read operations in accordance with the first sensing duration. Based on performing the first set of one or more read operations, the memory system may detect, at 410, that a quantity of bit errors associated with the first set of one or more read operations exceeds a threshold. Alternatively, the memory system may detect that the quantity of bit errors does not exceed the threshold, and the memory system may continue to 445 to continue nominal read operations. At 415, in response to detecting that the quantity of bit errors exceed the threshold, the memory system may enter an REH procedure and perform a second set of one or more read operations in accordance with one or more second sensing durations at 420 until exiting the REH procedure at 430 based on detecting the quantity of bit errors is less than (e.g., satisfies) the threshold at 425.

In some examples, the memory system may perform the first set of one or more read operations on a block family (e.g., a bin). A block family may include one or more blocks with similar data retention characteristics. For example, the memory system may write sequential data to the one or more blocks. Based on writing the sequential data, the blocks may have similar data retention. That is, writing the sequential data to the blocks within a relatively short time frame (e.g., compared to non-sequential writes) and at a relatively similar temperature may result in similar data retention characteristics for the one or more blocks. In some examples, the memory system may access blocks of the same block family via similar read voltages.

In some other memory systems, based on entering a REH procedure for a block of a block family, the other memory systems may apply a read last operation (e.g., a sticky read) to retrieve read information and read the block of the block family. Block family reads may be associated with reading sequential data because storing sequential data may result in a block family. Thus, reading from a block family may typically be based on performing a sequential read. However, the following read of a next block (e.g., or page) of the block family may result in the other memory systems applying another read last operation to retrieve the same, or similar, read information for the next block. The other memory systems may continue in this loop of reading a next block of a block family and retrieving the same read information to read that block for the entire block family, which may result in read performance degradation (e.g., finding the read information and performing the read last operation for each block in a block family may increase read durations for sequential reads). As described herein, the memory system may perform one or more read operations on one or more blocks of a block family in accordance with a shorter sensing time, which may improve read performance.

At 435, based on exiting the REH procedure, the memory system may perform a third set of one or more read operations on one or more blocks in accordance with the one or more second sensing durations. The one or more blocks may have also been subject to the first set of one or more operations (e.g., may be the same as one or more blocks on which the first set of one or more operations were performed). In some examples, the one or more blocks may be part of the same block family. For example, the memory system may perform the first set of one or more read operations as part of a sequential read. As described with reference to the sensing duration parameter in FIG. 3, in response to detecting that the first quantity of bit errors exceeds the threshold, the memory system may change the sensing duration parameter from the first value associated with the first sensing duration to the second value associated with the one or more second sensing durations. In some examples, the memory system may perform the third set of one or more read operations while the sensing duration parameter has the second value. In some other examples, the memory system may perform the third set of one or more read operations based on issuing read operations with the second sensing duration (e.g., without changing the sensing duration parameter).

At 440, the memory system may determine whether the sequential read is complete. That is, the memory system may determine if the all of the sequential data has been read from the family of blocks. If the memory system determines that the sequential read is not complete, the memory system may continue to perform the sequential read via the third set of one or more read operations. If the memory system determines that the sequential read is complete, the memory system may change the sensing duration parameter from the second value (e.g., the short sensing duration) to the first value (e.g., the normal sensing duration). Additionally, or alternatively, the memory system may cease the issue of read operations with the second sensing duration. At 445, the memory system may perform a fourth set one or more read operations in accordance with the first sensing duration (e.g., continue nominal read operations) based on changing the sensing duration parameter to the first value (e.g., or ceasing the issue of read operations using the shorter sensing duration).

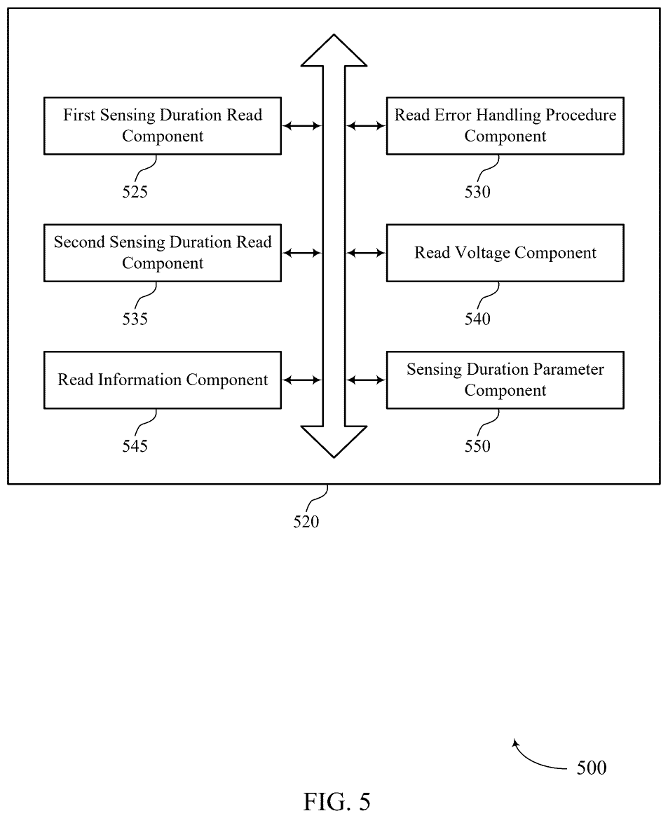

FIG. 5 shows a block diagram 500 of a memory system 520 that supports REH operations with shorter sensing time in accordance with examples as disclosed herein. The memory system 520 may be an example of aspects of a memory system as described with reference to FIGS. 1 through 4. The memory system 520, or various components thereof, may be an example of means for performing various aspects of REH operations with shorter sensing time as described herein. For example, the memory system 520 may include a first sensing duration read component 525, a REH procedure component 530, a second sensing duration read component 535, a read voltage component 540, a read information component 545, a sensing duration parameter component 550, or any combination thereof. Each of these components, or components of subcomponents thereof (e.g., one or more processors, one or more memories), may communicate, directly or indirectly, with one another (e.g., via one or more buses).

The first sensing duration read component 525 may be configured as or otherwise support a means for performing a first set of one or more read operations in accordance with a first sensing duration. The REH procedure component 530 may be configured as or otherwise support a means for entering a REH procedure based at least in part on detecting that a first quantity of bit errors exceeds a threshold, where the first quantity of bit errors is associated with the first set of one or more read operations. The second sensing duration read component 535 may be configured as or otherwise support a means for performing, during the REH procedure, a second set of one or more read operations in accordance with one or more second sensing durations, where the one or more second sensing durations are each shorter than the first sensing duration.

In some examples, the REH procedure component 530 may be configured as or otherwise support a means for exiting the REH procedure based at least in part on detecting that a second quantity of bit errors satisfies the threshold, where the second quantity of bit errors is associated with the second set of one or more read operations. In some examples, the second sensing duration read component 535 may be configured as or otherwise support a means for performing, in accordance with the one or more second sensing durations, a third set of one or more read operations on one or more blocks that were also subject to the first set of one or more read operations. In some examples, the first set of one or more read operations and the third set of one or more read operations are both associated with accessing sequential data stored in the one or more blocks.

In some examples, the sensing duration parameter component 550 may be configured as or otherwise support a means for changing, in response to detecting that the first quantity of bit errors exceeds the threshold, a sensing duration parameter from a first value associated with the first sensing duration to a second value associated with the one or more second sensing durations, where performing the third set of one or more read operations occurs while the sensing duration parameter has the second value.

In some examples, the sensing duration parameter component 550 may be configured as or otherwise support a means for changing the sensing duration parameter from the second value to the first value based at least in part on completing the third set of one or more read operations on the one or more blocks. In some examples, the first sensing duration read component 525 may be configured as or otherwise support a means for performing a fourth set of one or more read operations in accordance with the first sensing duration based at least in part on changing the sensing duration parameter to the first value.

In some examples, the read voltage component 540 may be configured as or otherwise support a means for performing the first set of one or more read operations includes applying a read voltage to one or more blocks in accordance with the first sensing duration. In some examples, the read voltage component 540 may be configured as or otherwise support a means for performing the second set of one or more read operations includes reapplying the read voltage to the one or more blocks in accordance with the one or more second sensing durations, where reapplying the read voltage is associated with a second quantity of bit errors fewer than the first quantity of bit errors.

In some examples, to support performing the second set of one or more read operations, the read information component 545 may be configured as or otherwise support a means for obtaining read information associated with one or more blocks, where the read information is associated with a read voltage applied to the one or more blocks during a previous REH procedure. In some examples, to support performing the second set of one or more read operations, the read voltage component 540 may be configured as or otherwise support a means for applying the read voltage to the one or more blocks in accordance with the one or more second sensing durations based at least in part on obtaining the read information, where applying the read voltage is associated with a second quantity of bit errors fewer than the first quantity of bit errors.

In some examples, performing the second set of one or more read operations is associated with a threshold voltage distribution shift of one or more corresponding memory cells relative to performing the first set of one or more read operations. In some examples, the first set of one or more read operations and the second set of one or more read operations are performed on one or more single-level memory cells.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

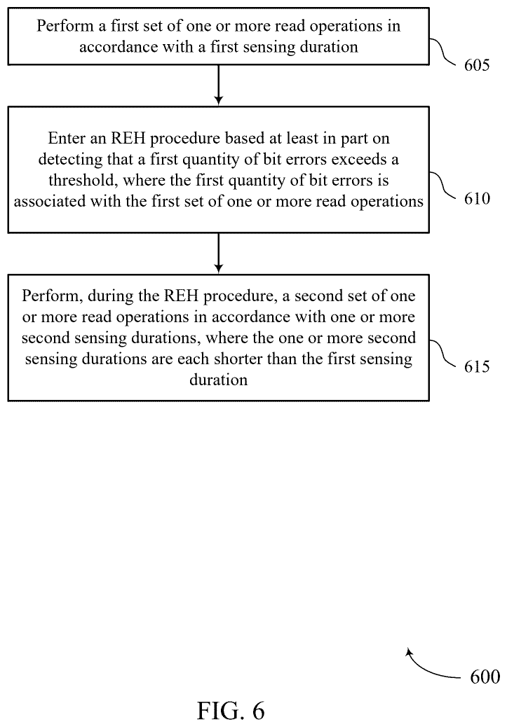

FIG. 6 shows a flowchart illustrating a method 600 that supports REH operations with shorter sensing time in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include performing a first set of one or more read operations in accordance with a first sensing duration. In some examples, aspects of the operations of 605 may be performed by a first sensing duration read component 525 as described with reference to FIG. 5.

At 610, the method may include entering a REH procedure based at least in part on detecting that a first quantity of bit errors exceeds a threshold, where the first quantity of bit errors is associated with the first set of one or more read operations. In some examples, aspects of the operations of 610 may be performed by a REH procedure component 530 as described with reference to FIG. 5.

At 615, the method may include performing, during the REH procedure, a second set of one or more read operations in accordance with one or more second sensing durations, where the one or more second sensing durations are each shorter than the first sensing duration. In some examples, aspects of the operations of 615 may be performed by a second sensing duration read component 535 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for performing a first set of one or more read operations in accordance with a first sensing duration; entering a REH procedure based at least in part on detecting that a first quantity of bit errors exceeds a threshold, where the first quantity of bit errors is associated with the first set of one or more read operations; and performing, during the REH procedure, a second set of one or more read operations in accordance with one or more second sensing durations, where the one or more second sensing durations are each shorter than the first sensing duration.

Aspect 2: The method, apparatus, or non-transitory computer-readable medium of aspect 1, further including operations, features, circuitry, logic, means, or instructions, or any combination thereof for exiting the REH procedure based at least in part on detecting that a second quantity of bit errors satisfies the threshold, where the second quantity of bit errors is associated with the second set of one or more read operations and performing, in accordance with the one or more second sensing durations, a third set of one or more read operations on one or more blocks that were also subject to the first set of one or more read operations.

Aspect 3: The method, apparatus, or non-transitory computer-readable medium of aspect 2, further including operations, features, circuitry, logic, means, or instructions, or any combination thereof for changing, in response to detecting that the first quantity of bit errors exceeds the threshold, a sensing duration parameter from a first value associated with the first sensing duration to a second value associated with the one or more second sensing durations, where performing the third set of one or more read operations occurs while the sensing duration parameter has the second value.

Aspect 4: The method, apparatus, or non-transitory computer-readable medium of aspect 3, further including operations, features, circuitry, logic, means, or instructions, or any combination thereof for changing the sensing duration parameter from the second value to the first value based at least in part on completing the third set of one or more read operations on the one or more blocks and performing a fourth set of one or more read operations in accordance with the first sensing duration based at least in part on changing the sensing duration parameter to the first value.

Aspect 5: The method, apparatus, or non-transitory computer-readable medium of any of aspects 2 through 4, where the first set of one or more read operations and the third set of one or more read operations are both associated with accessing sequential data stored in the one or more blocks.

Aspect 6: The method, apparatus, or non-transitory computer-readable medium of any of aspects 1 through 5, further including operations, features, circuitry, logic, means, or instructions, or any combination thereof for performing the first set of one or more read operations includes applying a read voltage to one or more blocks in accordance with the first sensing duration and performing the second set of one or more read operations includes reapplying the read voltage to the one or more blocks in accordance with the one or more second sensing durations, where reapplying the read voltage is associated with a second quantity of bit errors fewer than the first quantity of bit errors.

Aspect 7: The method, apparatus, or non-transitory computer-readable medium of any of aspects 1 through 6, where performing the second set of one or more read operations includes operations, features, circuitry, logic, means, or instructions, or any combination thereof for obtaining read information associated with one or more blocks, where the read information is associated with a read voltage applied to the one or more blocks during a previous REH procedure and applying the read voltage to the one or more blocks in accordance with the one or more second sensing durations based at least in part on obtaining the read information, where applying the read voltage is associated with a second quantity of bit errors fewer than the first quantity of bit errors.

Aspect 8: The method, apparatus, or non-transitory computer-readable medium of any of aspects 1 through 7, where performing the second set of one or more read operations is associated with a threshold voltage distribution shift of one or more corresponding memory cells relative to performing the first set of one or more read operations.

Aspect 9: The method, apparatus, or non-transitory computer-readable medium of any of aspects 1 through 8, where the first set of one or more read operations and the second set of one or more read operations are performed on one or more single-level memory cells.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or Cor AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
perform a first set of one or more read operations in accordance with a first sensing duration;
enter a read error handling procedure based at least in part on detecting that a first quantity of bit errors exceeds a threshold, wherein the first quantity of bit errors is associated with the first set of one or more read operations; and
perform, during the read error handling procedure, a second set of one or more read operations in accordance with one or more second sensing durations, wherein the one or more second sensing durations are each shorter than the first sensing duration.

2. The memory system of claim 1, wherein the processing circuitry is further configured to cause the memory system to:
exit the read error handling procedure based at least in part on detecting that a second quantity of bit errors satisfies the threshold, wherein the second quantity of bit errors is associated with the second set of one or more read operations; and
perform, in accordance with the one or more second sensing durations, a third set of one or more read operations on one or more blocks that were also subject to the first set of one or more read operations.

3. The memory system of claim 2, wherein the processing circuitry is further configured to cause the memory system to:
change, in response to detecting that the first quantity of bit errors exceeds the threshold, a sensing duration parameter from a first value associated with the first sensing duration to a second value associated with the one or more second sensing durations, wherein the processing circuitry is configured to cause the memory system to perform the third set of one or more read operations while the sensing duration parameter has the second value.

4. The memory system of claim 3, wherein the processing circuitry is further configured to cause the memory system to:
change the sensing duration parameter from the second value to the first value based at least in part on completing the third set of one or more read operations on the one or more blocks; and
perform a fourth set of one or more read operations in accordance with the first sensing duration based at least in part on changing the sensing duration parameter to the first value.

5. The memory system of claim 2, wherein the first set of one or more read operations and the third set of one or more read operations are both associated with accessing sequential data stored in the one or more blocks.

6. The memory system of claim 1, wherein:
to perform the first set of one or more read operations, the processing circuitry is configured to cause the memory system to apply a read voltage to one or more blocks in accordance with the first sensing duration; and
to perform the second set of one or more read operations, the processing circuitry is configured to cause the memory system to reapply the read voltage to the one or more blocks in accordance with the one or more second sensing durations, wherein reapplying the read voltage is associated with a second quantity of bit errors fewer than the first quantity of bit errors.

7. The memory system of claim 1, wherein, to perform the second set of one or more read operations, the processing circuitry is configured to cause the memory system to:
obtain read information associated with one or more blocks, wherein the read information is associated with a read voltage applied to the one or more blocks during a previous read error handling procedure; and
apply the read voltage to the one or more blocks in accordance with the one or more second sensing durations based at least in part on obtaining the read information, wherein applying the read voltage is associated with a second quantity of bit errors fewer than the first quantity of bit errors.

8. The memory system of claim 1, wherein performing the second set of one or more read operations is associated with a threshold voltage distribution shift of one or more corresponding memory cells relative to performing the first set of one or more read operations.

9. The memory system of claim 1, wherein the first set of one or more read operations and the second set of one or more read operations are performed on one or more single-level memory cells.

10. A method by a memory system, comprising:
performing a first set of one or more read operations in accordance with a first sensing duration;
entering a read error handling procedure based at least in part on detecting that a first quantity of bit errors exceeds a threshold, wherein the first quantity of bit errors is associated with the first set of one or more read operations; and
performing, during the read error handling procedure, a second set of one or more read operations in accordance with one or more second sensing durations, wherein the one or more second sensing durations are each shorter than the first sensing duration.

11. The method of claim 10, further comprising:
exiting the read error handling procedure based at least in part on detecting that a second quantity of bit errors satisfies the threshold, wherein the second quantity of bit errors is associated with the second set of one or more read operations; and
performing, in accordance with the one or more second sensing durations, a third set of one or more read operations on one or more blocks that were also subject to the first set of one or more read operations.

12. The method of claim 11, further comprising:
changing, in response to detecting that the first quantity of bit errors exceeds the threshold, a sensing duration parameter from a first value associated with the first sensing duration to a second value associated with the one or more second sensing durations, wherein performing the third set of one or more read operations occurs while the sensing duration parameter has the second value.

13. The method of claim 12, further comprising:
changing the sensing duration parameter from the second value to the first value based at least in part on completing the third set of one or more read operations on the one or more blocks; and
performing a fourth set of one or more read operations in accordance with the first sensing duration based at least in part on changing the sensing duration parameter to the first value.

14. The method of claim 11, wherein the first set of one or more read operations and the third set of one or more read operations are both associated with accessing sequential data stored in the one or more blocks.

15. The method of claim 10, wherein:
performing the first set of one or more read operations comprises applying a read voltage to one or more blocks in accordance with the first sensing duration; and
performing the second set of one or more read operations comprises reapplying the read voltage to the one or more blocks in accordance with the one or more second sensing durations, wherein reapplying the read voltage is associated with a second quantity of bit errors fewer than the first quantity of bit errors.

16. The method of claim 10, wherein performing the second set of one or more read operations comprises:
obtaining read information associated with one or more blocks, wherein the read information is associated with a read voltage applied to the one or more blocks during a previous read error handling procedure; and
applying the read voltage to the one or more blocks in accordance with the one or more second sensing durations based at least in part on obtaining the read information, wherein applying the read voltage is associated with a second quantity of bit errors fewer than the first quantity of bit errors.

17. The method of claim 10, wherein performing the second set of one or more read operations is associated with a threshold voltage distribution shift of one or more corresponding memory cells relative to performing the first set of one or more read operations.

18. The method of claim 10, wherein the first set of one or more read operations and the second set of one or more read operations are performed on one or more single-level memory cells.

19. A non-transitory computer-readable medium storing code, the code comprising instructions executable by one or more processors to:
perform a first set of one or more read operations in accordance with a first sensing duration;
enter a read error handling procedure based at least in part on detecting that a first quantity of bit errors exceeds a threshold, wherein the first quantity of bit errors is associated with the first set of one or more read operations; and
perform, during the read error handling procedure, a second set of one or more read operations in accordance with one or more second sensing durations, wherein the one or more second sensing durations are each shorter than the first sensing duration.

20. The non-transitory computer-readable medium of claim 19, wherein the instructions are further executable by the one or more processors to:
exit the read error handling procedure based at least in part on detecting that a second quantity of bit errors satisfies the threshold, wherein the second quantity of bit errors is associated with the second set of one or more read operations; and
perform, in accordance with the one or more second sensing durations, a third set of one or more read operations on one or more blocks that were also subject to the first set of one or more read operations.

21. The non-transitory computer-readable medium of claim 20, wherein the instructions are further executable by the one or more processors to:
change, in response to detecting that the first quantity of bit errors exceeds the threshold, a sensing duration parameter from a first value associated with the first sensing duration to a second value associated with the one or more second sensing durations, wherein the instructions are executable by the one or more processors to perform the third set of one or more read operations while the sensing duration parameter has the second value.

22. The non-transitory computer-readable medium of claim 20, wherein the first set of one or more read operations and the third set of one or more read operations are both associated with accessing sequential data stored in the one or more blocks.

23. The non-transitory computer-readable medium of claim 19, wherein:
to perform the first set of one or more read operations, the instructions are executable by the one or more processors to apply a read voltage to one or more blocks in accordance with the first sensing duration; and
to perform the second set of one or more read operations, the instructions are executable by the one or more processors to reapply the read voltage to the one or more blocks in accordance with the one or more second sensing durations, wherein reapplying the read voltage is associated with a second quantity of bit errors fewer than the first quantity of bit errors.

24. The non-transitory computer-readable medium of claim 19, wherein, to perform the second set of one or more read operations, the instructions are executable by the one or more processors to:
obtain read information associated with one or more blocks, wherein the read information is associated with a read voltage applied to the one or more blocks during a previous read error handling procedure; and
apply the read voltage to the one or more blocks in accordance with the one or more second sensing durations based at least in part on obtaining the read information, wherein applying the read voltage is associated with a second quantity of bit errors fewer than the first quantity of bit errors.

25. The non-transitory computer-readable medium of claim 19, wherein, to perform the second set of one or more read operations, the instructions are executable by the one or more processors to:
obtain read information associated with one or more blocks, wherein the read information is associated with a read voltage applied to the one or more blocks during a previous read error handling procedure; and
apply the read voltage to the one or more blocks in accordance with the one or more second sensing durations based at least in part on obtaining the read information, wherein applying the read voltage is associated with a second quantity of bit errors fewer than the first quantity of bit errors.
